(19) United States
(12) Patent Application Publication
(10) Pub. No.: US 2023/0019410 A1
(43) Pub. Date: Jan. 19, 2023

(54) SYSTEMS AND METHODS FOR BIAS PROFILING OF DATA SOURCES

(71) Applicant: Qatar Foundation for Education, Science and Community Development, Doha (QA)

(72) Inventors: Preslav I. Nakov, Doha (QA); Panayot Panayotov, Doha (QA); Utsav Shukla, Doha (QA); Husrev Taha Sencar, Doha (QA)

(21) Appl. No.: 17/865,963

(22) Filed: Jul. 15, 2022

Related U.S. Application Data
(60) Provisional application No. 63/222,173, filed on Jul. 15, 2021.

(51) Int. Cl. G06F 16/906; G06F 16/907; G06N 3/02; G06K 9/62

(52) U.S. Cl. CPC G06F 16/906; G06F 16/907; G06N 3/02; G06K 9/6215

(57) ABSTRACT

The present disclosure provides new and innovative systems and methods for profiling bias for data sources, specifically publishers of news articles. A variety of embodiments include a computer-implemented method for profiling a data source includes obtaining an indication of a first data source, determining visitor and keyword data for the first data source, determining metadata for the first data source, generating a source similarity graph for the first data source, the source similarity graph indicating at least one similar data source and, for each similar data source, a bias score for the similar data source, classifying the first data source based on the bias scores for the at least one similar data source, generating a notification indicating the first data source and the classification of the first data source, and providing the notification.

### CROSS-REFERENCE TO RELATED APPLICATIONS

The instant application claims priority to U.S. Provisional Patent Application No. 63/222,173, entitled “Graph Neural Networks for News Media Profiling” and filed Jul. 15, 2021, the disclosure of which is hereby incorporated by reference in its entirety.

### FIELD OF THE INVENTION

The instant application relates to computer systems and more specifically to classifying data sources using machine learning.

### BACKGROUND

Various news events and other information can be provided to consumers across a variety of media, such as television, radio, or the Internet. This content may include material such as sports coverage, weather forecasts, traffic reports, political commentary, expert opinions, editorial content, and other material that the broadcaster feels is relevant to their audience.

### SUMMARY OF THE INVENTION

The present disclosure provides new and innovative systems and methods for profiling bias for data sources, specifically publishers of news articles. A variety of embodiments include a computer-implemented method for profiling a data source includes obtaining an indication of a first data source, determining visitor and keyword data for the first data source, determining metadata for the first data source, generating a source similarity graph for the first data source, the source similarity graph indicating at least one similar data source and, for each similar data source, a bias score for the similar data source, classifying the first data source based on the bias scores for the at least one similar data source, generating a notification indicating the first data source and the classification of the first data source, and providing the notification.

In a variety of embodiments, the metadata includes data selected from the group including traffic rank data, bounce rate data, daily page views per visitor data, and time on site per visitor data.

In a variety of embodiments, the method further includes obtaining the metadata using a third party server system.

In a variety of embodiments, the method further includes obtaining the metadata using a local web traffic analyzer.

In a variety of embodiments, the source similarity graph includes an indication of a historical classification for the first data source.

In a variety of embodiments, the method further includes generating the bias score by traversing the source similarity graph using a graph neural network.

In a variety of embodiments, the notification is selected from the group consisting of a push notification, an email notification, a text message, and an audible alert.

A variety of embodiments include a data source profiling device includes a processor and memory storing instructions that, when read by the processor, cause the data source profiling device to obtain an indication of a first data source, determine visitor and keyword data for the first data source, determine metadata for the first data source, generate a source similarity graph for the first data source, the source similarity graph indicating at least one similar data source and, for each similar data source, a bias score for the similar data source, classify the first data source based on the bias scores for the at least one similar data source, generate a notification indicating the first data source and the classification of the first data source, and provide the notification.

In a variety of embodiments, the metadata includes data selected from the group consisting of traffic rank data, bounce rate data, daily page views per visitor data, and time on site per visitor data.

In a variety of embodiments, the metadata is obtained using a third party server system.

In a variety of embodiments, the metadata is obtained using a local web traffic analyzer.

In a variety of embodiments, the source similarity graph includes an indication of a historical classification for the first data source.

In a variety of embodiments, the bias score is generated by traversing the source similarity graph using a graph neural network.

In a variety of embodiments, the notification is selected from the group consisting of a push notification, an email notification, a text message, and an audible alert.

A variety of embodiments include a non-transitory computer readable medium storing instructions that, when executed by one or more processors, cause the one or more processors to perform steps including obtaining an indication of a first data source, determining visitor and keyword data for the first data source, determining metadata for the first data source, generating a source similarity graph for the first data source, the source similarity graph indicating at least one similar data source and, for each similar data source, a bias score for the similar data source, classifying the first data source based on the bias scores for the at least one similar data source, generating a notification indicating the first data source and the classification of the first data source, and providing the notification.

In a variety of embodiments, wherein the metadata includes data selected from the group consisting of traffic rank data, bounce rate data, daily page views per visitor data, and time on site per visitor data.

In a variety of embodiments, the instructions, when executed by one or more processors, further cause the one or more processors to perform steps including obtaining the metadata using a third party server system.

In a variety of embodiments, the instructions, when executed by one or more processors, further cause the one or more processors to perform steps including obtaining the metadata using a local web traffic analyzer.

In a variety of embodiments, the instructions, when executed by one or more processors, further cause the one or more processors to perform steps including generating the bias score by traversing the source similarity graph using a graph neural network.

In a variety of embodiments, the notification is selected from the group consisting of a push notification, an email notification, a text message, and an audible alert.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary embodiments of the disclosure and should not be construed as a complete recitation of the scope of the disclosure, wherein:

FIG. 1 is a conceptual illustration of an operating environment in accordance with an example embodiment of the present disclosure;

FIG. 2 is a conceptual illustration of a computing device in accordance with an example embodiment of the present disclosure;

FIG. 3A illustrates a flowchart of a process for classifying a data source in accordance with an example embodiment of the present disclosure;

FIG. 3B is a conceptual illustration of a source similarity graph in accordance with an example embodiment of the present disclosure;

FIG. 3C is a conceptual illustration of a data source classification in accordance with an example embodiment of the present disclosure;

FIG. 4 illustrates a flowchart of a process generating a node for a data source according to an example embodiment of the present disclosure;

FIG. 5 illustrates a flowchart of a process for determining metadata for a data source in accordance with an example embodiment of the present disclosure;

FIG. 6 illustrates a flowchart of a process for generating a source similarity graph in accordance with an example embodiment of the present disclosure; and

FIG. 7 illustrates a flowchart of a process for classifying a data source in accordance with an example embodiment of the present disclosure.

### DETAILED DESCRIPTION

Turning now to the drawings, systems and methods for profiling data sources in accordance with a variety of embodiments of the invention are disclosed. Modern media reporting is plagued with the specter of disinformation and fake news. Consumers approach media outlets with the hope of receiving bona fide journalism. However, many media outlets skew their coverage on account of a particular bias, often peddling in divisive and false news reporting. This leads to a self-reinforcing cycle wherein consumers who are drawn to these outlets have a tough time noticing the issues with the news they consume. Indeed, consumers who frequent a particular media outlet will be inclined to disbelieve another outlet's competing narrative, notwithstanding that the consumed outlet might be the purveyor of untruths. Typical news classification systems focus on the content of particular news articles. However, these systems can help reveal the intent of an article, an evaluation of the authenticity and the objectivity of the claims stated in the article are beyond the capabilities of these systems.

Data source profiling systems in accordance with embodiments of the invention classify data sources to determine factuality and bias for the data source. Media outlets can provide one or more data sources including a variety of videos, podcasts, news articles, and the like. In a variety of embodiments, the system profiles the data sources for a media outlet. The data source profiling system generates a source similarity graph that describes the data sources and can determine a variety of metrics, such as factuality and/or bias scores, for a particular data source. In this way, data source profiling systems can determine the likelihood that a particular data source is a source of true information and/or false or misleading information and provide a variety of notifications and/or recommendations regarding particular data sources as described herein. In particular, data profiling systems can profile (e.g. classify) a data source based on media audience homophily, audience engagement, and/or media popularity. In a variety of embodiments, the classifications of data sources can be augmented using classifications based on textual representations extracted from the articles published via the data source. Data source profiling systems can store, using a data source database, information regarding the data sources and the metadata for each data source along with source similarity graphs and/or classifications for each data source.

Data source profiling systems in accordance with embodiments of the invention provide an improved data structure for storing information regarding data sources and provide improved solutions for determining the reliability of data sources. In contrast to typical systems, which focus primarily on text (e.g., on the text of the articles published by the target website, or on the textual description in their social media profiles or in Wikipedia), data source profiling systems model the similarity between media outlets based on the overlap of their audience. The data source profiling system generates a source similarity graph that encodes relationships between data sources and similarities in factuality and bias between different data sources. In particular, the encoding of the data source and its metadata within the data source database facilitates the generation of source similarity graphs and the classification of the data sources using a variety of techniques, such as by using machine classifiers as described herein. Additionally, the data source database can store multiple versions of source similarity graphs and/or classifications for a particular data source over time. For example, this historical data can be used to track the reliability and/or bias of a particular data source over time. This improves the ability of the data source profiling systems to store data and process, thereby improving the function of the data source profiling system itself, particularly as compared to existing solutions.

A variety of data source profiling systems and data source profiling processes in accordance with embodiments of the invention are described in more detail below.

### Operating Environments and Computing Devices

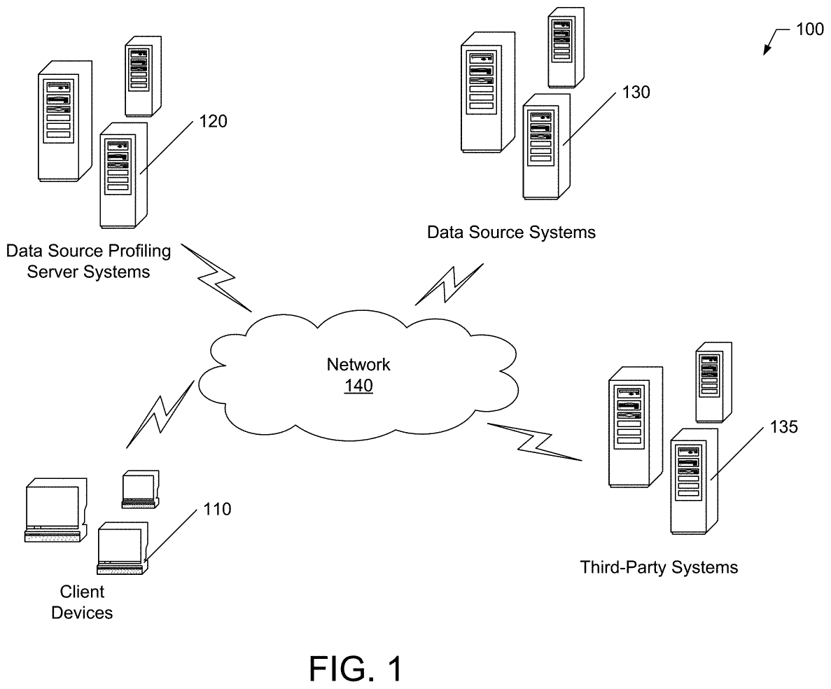

FIG. 1 illustrates a block diagram of an operating environment 100 in accordance with one or more embodiments of the present disclosure. The operating environment 100 can include client devices 110, data source profiling server systems 120, data source systems 130, and/or third-party system 135 in communication via network 140. In many embodiments, the data source profiling server systems 120, data source systems 130, and/or third-party system 135 are implemented using a single server. In a variety of embodiments, the data source profiling server systems 120, data source systems 130, and/or third-party system 135 are implemented using a plurality of servers. In several embodiments, the client devices 110 are implemented using the data source profiling server systems 120. In a variety of embodiments, the data source profiling server systems 120 are implemented using the client devices 110.

Client devices 110 can provide requests for classification of particular data sources, obtain notifications regarding a particular data source, and or provide those notifications. Data source profiling server systems 120 can obtain indications of data sources, obtain and/or generate metadata regarding the data sources, generate and maintain source similarity graphs, obtain requests to classify a data source, classify data sources, and generate and provide notifications regarding data sources. Data source systems 130 and/or third-party system 135 can provide media and/or metadata regarding the data source and/or media as described herein. It should be noted that any data described herein can be provided by any device described herein and can be transmitted between client devices 110, data source profiling server systems 120, data source systems 130, and/or third-party system 135 via network 140 as appropriate.

The network 140 can include a LAN (local area network), a WAN (wide area network), telephone network (e.g. Public Switched Telephone Network (PSTN)), Session Initiation Protocol (SIP) network, wireless network, point-to-point network, star network, token ring network, hub network, wireless networks (including protocols such as EDGE, 3G, 4G LTE, Wi-Fi, 5G, WiMAX, and the like), the Internet, and the like. A variety of authorization and authentication techniques, such as username/password, Open Authorization (OAuth), Kerberos, SecureID, digital certificates, and more, may be used to secure the communications. It will be appreciated that the network connections shown in the operating environment 100 are illustrative, and any means of establishing one or more communications links between the computing devices may be used.

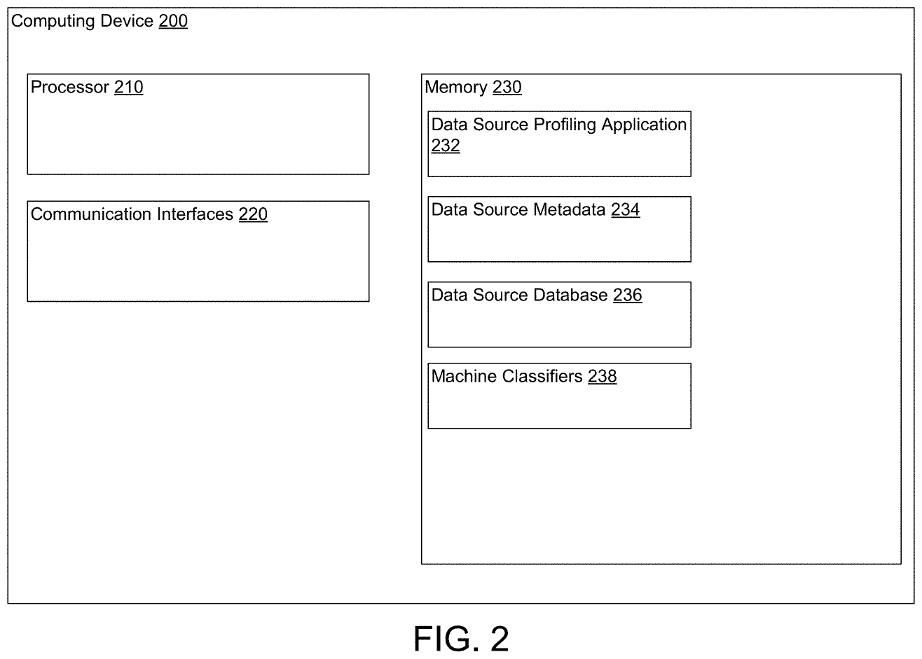

Any of the devices shown in FIG. 1 (e.g. client devices 110, data source profiling server systems 120, data source systems 130, and/or third-party system 135) can include a single computing device, multiple computing devices, a cluster of computing devices, and the like. A conceptual illustration of a computing device in accordance with an embodiment of the invention is shown in FIG. 2. The computing device 200 includes a processor 210 in communication with memory 230. The computing device 200 can also include one or more communication interfaces 220 capable of sending and receiving data. In a number of embodiments, the communication interface 220 is in communication with the processor 210 and/or the memory 230. In several embodiments, the memory 230 is any form of storage storing a variety of data, including, but not limited to, a data source profiling application 232, data source metadata 234, data source database 236, and/or machine classifiers 238. In many embodiments, some or all of this data is stored using an external server system and received by the computing device 200 using the communications interface 220. The processor 210 can be directed, via one or more instructions in the data source profiling application 232, to perform a variety of data source profiling processes as described herein.

The processor 210 can include one or more physical processors communicatively coupled to memory devices, input/output devices, and the like. As used herein, a processor may also be referred to as a central processing unit (CPU). Additionally, as used herein, a processor can include one or more devices capable of executing instructions encoding arithmetic, logical, and/or I/O operations. In one illustrative example, a processor may implement a Von Neumann architectural model and may include an arithmetic logic unit (ALU), a control unit, and a plurality of registers. In many embodiments, a processor may be a single core processor that is typically capable of executing one instruction at a time (or process a single pipeline of instructions) and/or a multi-core processor that may simultaneously execute multiple instructions. In a variety of embodiments, a processor may be implemented as a single integrated circuit, two or more integrated circuits, and/or may be a component of a multi-chip module in which individual microprocessor dies are included in a single integrated circuit package and hence share a single socket. Memory 230 can include a volatile or non-volatile memory device, such as RAM, ROM, EEPROM, or any other device capable of storing data. Communication devices 220 can include network devices (e.g., a network adapter or any other component that connects a computer to a computer network), a peripheral component interconnect (PCI) device, storage devices, disk drives, printer devices, keyboards, displays, etc.

Although specific architectures for computing devices in accordance with embodiments of the invention are conceptually illustrated in FIG. 2, any of a variety of architectures, including those that store data or applications on disk or some other form of storage and are loaded into memory at runtime, can also be utilized. Additionally, any of the data utilized in the system can be cached and transmitted once a network connection (such as a wireless network connection via the communications interface) becomes available. In several embodiments, the computing device 200 provides an interface, such as an API or web service, which provides some or all of the data to other computing devices for further processing. Access to the interface can be open and/or secured using any of a variety of techniques, such as by using client authorization keys, as appropriate to the requirements of specific applications of the disclosure. In a variety of embodiments, a memory includes circuitry such as, but not limited to, memory cells constructed using transistors, that store instructions. Similarly, a processor can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Data Source Profiling Processes

In a variety of embodiments, data source profiling processes include characterizing the similarity between data sources in terms of their factuality of reporting and political bias. In order to determine similar data sources, a variety of metadata, including audience similarity can be used. In particular, if an audience has a common interest in some data sources, then those data sources are likely similar in some respects. Similar data sources can be used to generate a source similarity graph for a data source that identifies data sources that are similar to and/or different from the data source. The data source can be classified based on the source similarity graph and notifications can be provided that indicate the determined classification. In a variety of embodiments, the metadata for a data source includes a variety of user engagement statistics in order to better model the relationships between data sources.

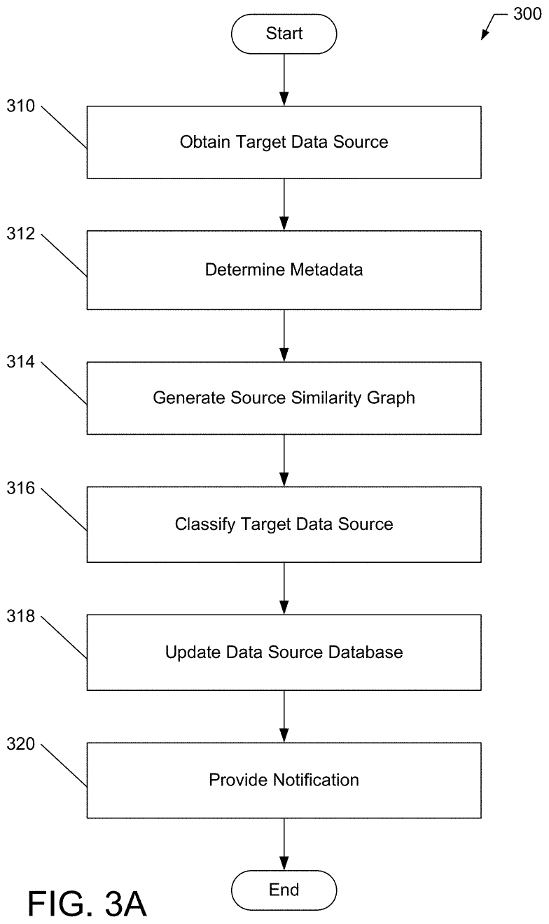

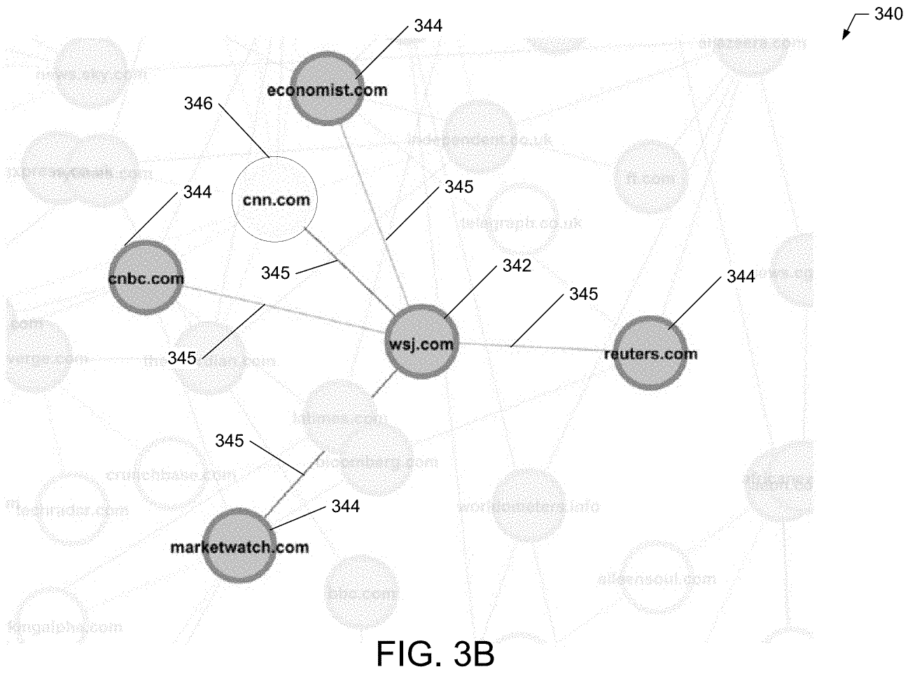

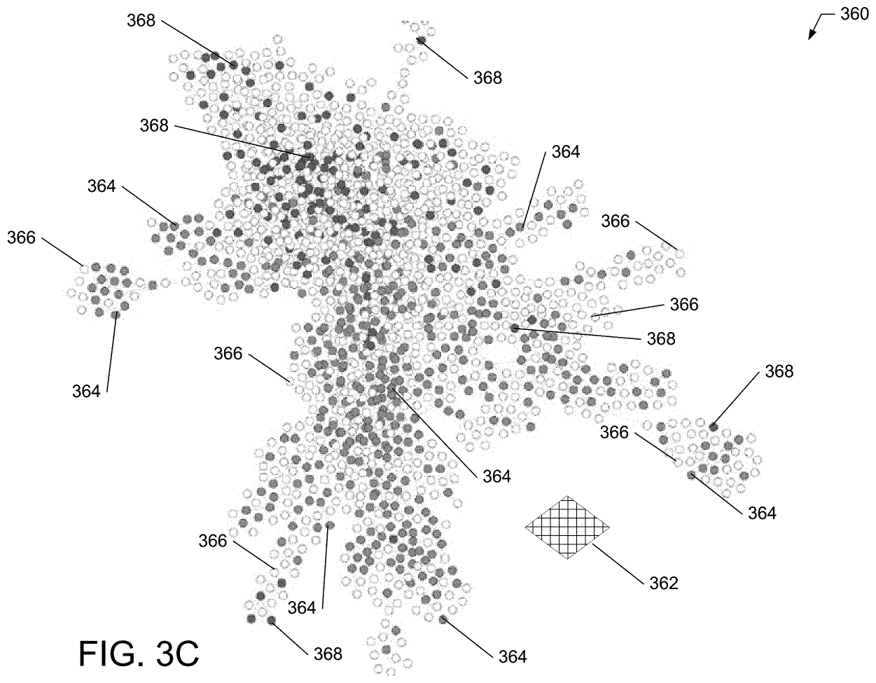

FIG. 3A illustrates a flowchart of a process for classifying a data source in accordance with an example embodiment of the present disclosure. The process 300 includes obtaining (310) a target data source. In many embodiments, a data source is obtained using a reference, such as a the Uniform Resource Locator (URL), that can be used to locate and/or access the data source via a network. However, any indication of a data source, such as an Internet Protocol (IP) address, can be used to identify the target data source in accordance with embodiments of the invention.

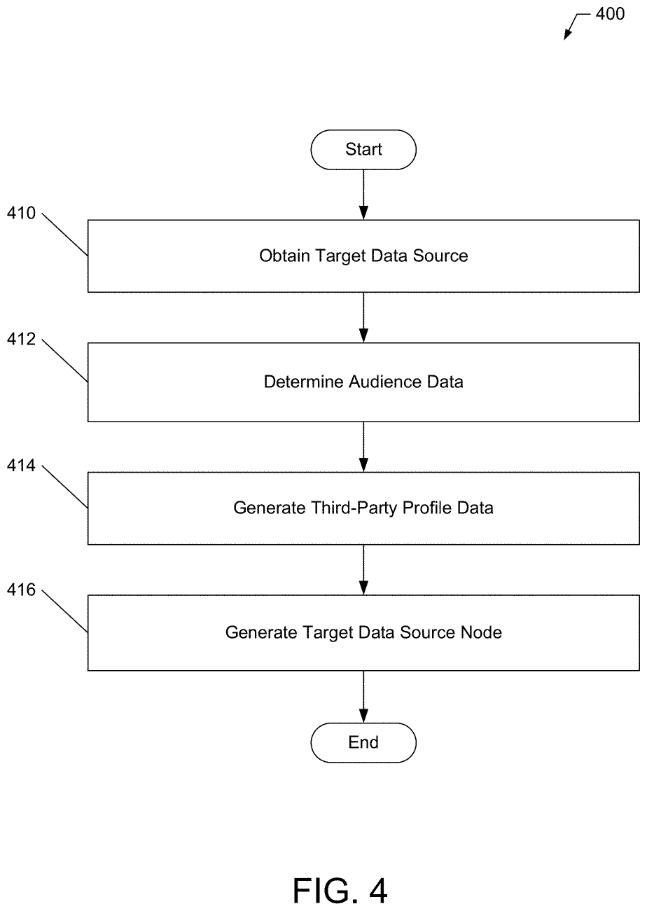

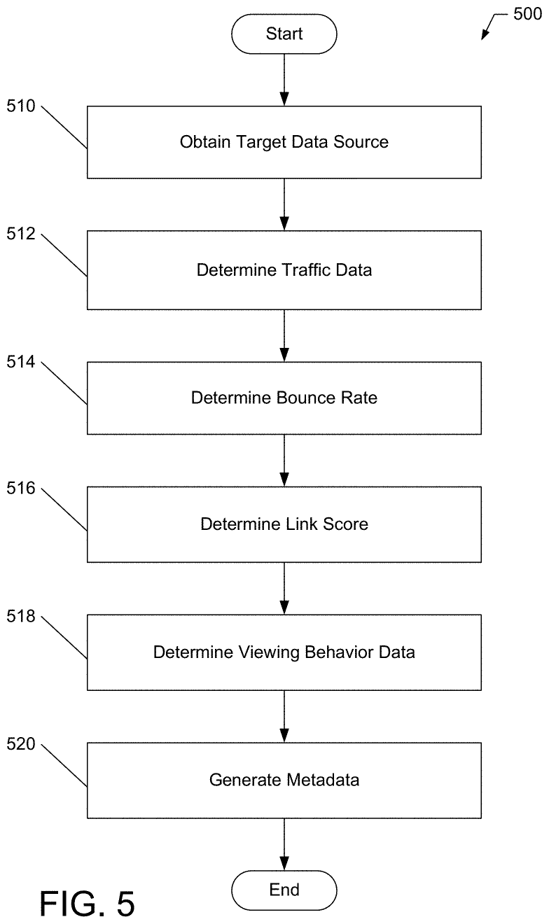

Metadata can be determined (312). The metadata for a particular data source can include a variety of data including audience data, a visitor profile, traffic data, bounce rate, link scores, viewing behavior data, and the like. In particular, the metadata can be used to provide an accurate characterization of a data source and identify similar data sources within a data source database. A variety of processes for generating a node for a data source are described herein, particularly with respect to FIG. 4. A variety of processes for determining a variety of metadata for a data source are described herein, particularly with respect to FIG. 5.

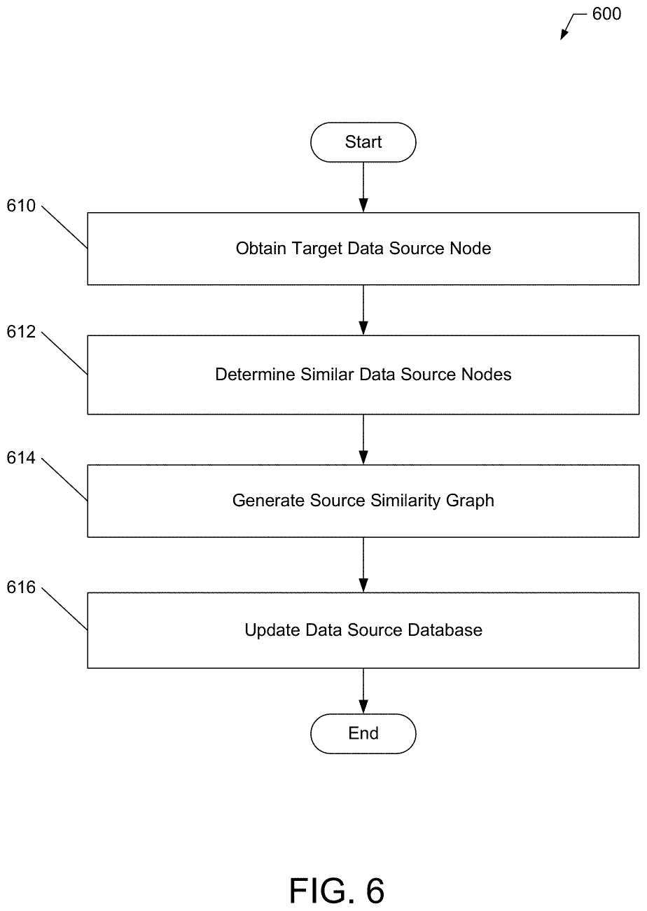

A source similarity graph can be generated (314). The source similarity graph identifies data sources that are similar to the target data source. In a variety of embodiments, the similar data sources are determined based on the metadata associated with each data source. Turning now to FIG. 3B, a conceptual illustration of a source similarity graph in accordance with an example embodiment of the present disclosure is shown. The source similarity graph 340 includes a target node 342, a set of similar nodes 344, and a neutral node 346. Each of the similar nodes 344 and the neutral node 346 are connected to the target node 342 via an edge 345 indicating that a relationship exists between the data sources; the relationship based on the metadata associated with the data sources and/or obtained from a third-party database as described herein. In a variety of embodiments, each of the similar nodes 344 can be used to classify the target node 342, while the neutral node 346 will be excluded from the classification. In several embodiments, each node can be weighted with respect to the target node 342 (e.g. based on if the node is similar, neutral, or different) and the weights can be used in classifying the target node 342 as appropriate. A variety of processes for generating a source similarity graph are described herein, particularly with respect to FIG. 6.

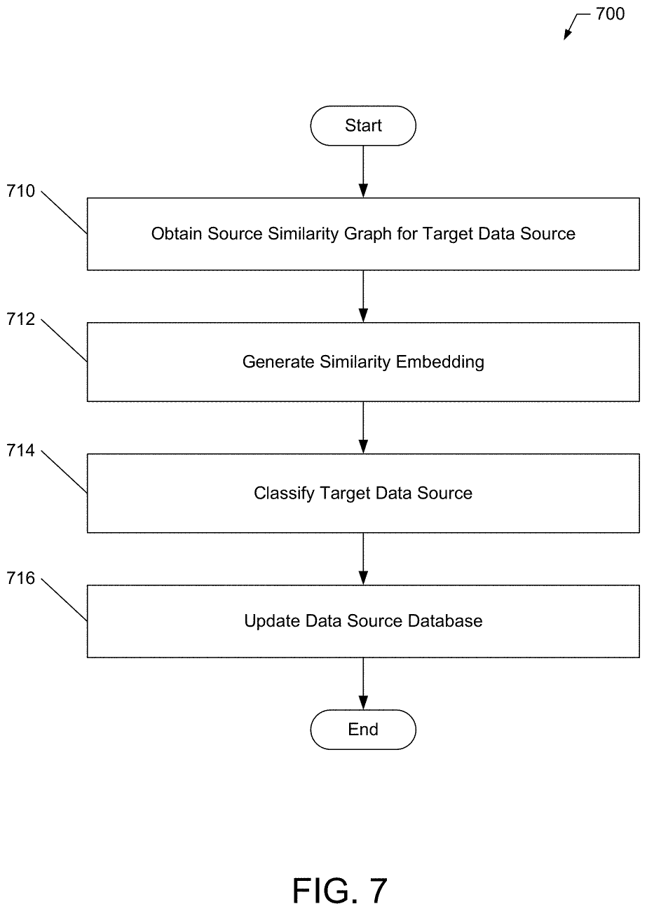

The target data source can be classified (316). The classification can indicate the bias and/or reliability of the target data source. Turning now to FIG. 3C, a conceptual illustration of a classification of a data source in accordance with an example embodiment of the present disclosure is shown. The data source classification 360 includes a target data source node 362, a set of factual data source nodes 364, a set of mixed data source nodes 366, and a set of unreliable data source nodes 368. It should be noted that factual, mixed, and unreliable correspond to a label assigned to each node during the classification each node and that any labels (including more or fewer labels) can be used as appropriate to the requirements of specific applications of embodiments of the invention. In many embodiments, one or more machine classifiers can be used to classify the target data source node 362 based on a similarity graph for the target data source node 362 and the labels associated with the factual data source nodes 364, a set of mixed data source nodes 366, and a set of unreliable data source nodes 368. A variety of processes for classifying data sources are described herein, particularly with respect to FIG. 7.

A data source database can be updated (318). The data source can be updated to insert and/or update a node corresponding to the target data source. For example, a node associated with a new target data source can be inserted into the data source database, while an existing node can be updated. Each node can be associated with the determined metadata, source similarity graph, and/or classification, which can also be stored in the data source database. In several embodiments, a node includes historical versions of the metadata, source similarity graphs, and/or classifications. In this way, the trend of the classification of the target data source can be tracked over time. In many embodiments, the metadata, source similarity graphs, and/or classifications can be updated as new data becomes available and/or as new nodes are added to the data source database. These updates can be performed in parallel and/or serially, on-demand, in batch, and/or in real time as appropriate to the requirements of specific applications of embodiments of the invention. In this way, the data source database can be updated and maintained to reflect the current conditions and/or biases of the tracked data sources.

In many embodiments, notifications can be provided (320). The notifications can indicate the target data source, the similar data sources (and/or any other data sources indicated in the source similarity graph), one or more labels indicating the classification of the target data source, a date and/or time the classification was made, metadata associated with the data source, and/or any other information regarding the target data source. The notifications can be stored using the data source database and/or provided to any of the computing devices described herein. The notifications can be push notifications, email notifications, text messages, audible alerts, visual alerts, and/or any other notification appropriate to the specific computing device receiving the notification. The notifications can cause the receiving computing device to provide the notification to a user.

Specific processes for classifying a data source in accordance with the invention are described with respect to FIG. 3A and examples of source similarity graphs and data source classifications are described with respect to FIGS. 3B-C. However, any of a variety of processes, including those that use attributes other than those indicated above to identify similar data sources and/or classify data sources, can be used as appropriate to the requirements of specific applications of the embodiments of the invention.

Data source profiling processes can include generating representations of data sources and adding those data sources to a data source database. In generating the representation of a data source, audience data for the data source can be determined. For example, given a specific data source, an observation is made that individuals who interact with this data source will interact with other data sources with similar factuality and bias scores. Thus, by determining a given data source's audience data, similar data sources can be reliably identified. This follows the homophily principle, which states that similar individuals interact with each other at a higher rate than with dissimilar ones.

FIG. 4 illustrates a flowchart of a process for generating a node for a data source according to an example embodiment of the present disclosure. The process 400 includes obtaining (410) a target data source. The target data source can be obtained in a variety of ways, such as via a locator as described herein.

Audience data can be determined (412). The audience data for a target data source can include the number and/or characteristics of users who visit the target data source. For example, the audience for a data source can be users who read news articles hosted by the target data source. The audience data can be obtained from the target data source itself, measured using one or more tracking tools, and/or obtained from a third-party database as appropriate. For example, third-party systems, such as Alexa, produce statistics about the browsing behavior of Internet users for a variety of data sources. These statistics can be computed over a rolling window and updated daily (or any other schedule). The generated statistics can be obtained directly from the data sources (e.g. from those data sources hosting a tracking script provided by the third-party systems) and/or estimated from a sample of data generated by millions of users using one of several browser extensions and plug-ins provided by the third-party systems.

Third-party profile data can be generated (414). The third-party profile data can indicate the behavior of users indicated in the audience data across a wide variety of platforms, such as social media sites, Social media sites include, but are not limited to, Facebook, Twitter, YouTube, and any other site that hosts user-generated content as appropriate. The third-party profile data can include indications of how the users describe themselves in their publicly accessible profiles, engagement with social media content (e.g. the number of comments, views, likes, dislikes, and the like), and/or demographic information for the audience. This data can be used to obtain the audience distribution over the political spectrum. The distribution can be divided into five categories and each data source can be labeled accordingly.

A node for the target data source can be generated (416). The node can include an indication of the target data source, the audience data, and/or the third-party audience data. In many embodiments, the node includes one or more labels generated based on the audience data and/or the third-party audience data. For example, a label indicating a political bias for the audience can be generated based on engagement with social media and/or demographic information for the audience. However, it should be noted that any label for any characteristic of the audience can be used as appropriate. These labels can be indicated in the target data source node and provide a convenient mechanism for quickly identifying similar data sources as described herein.

Specific processes for generating a node for a data source in accordance with the invention are described in FIG. 4. However, it should be understood that any variety of processes, including those that do not utilize audience data and/or that include additional data, can be used as appropriate to the requirements of the specific application of the embodiments of the invention.

Data source profiling processes can include generating a variety of metadata regarding a data source. This metadata can described any of a variety of features and/or metrics of a data source. In particular, the metadata can be used to assist in the identification of similar data sources and/or classify data sources as described herein.

FIG. 5 illustrates a flowchart of a process for determining metadata for a data source in accordance with an example embodiment of the present disclosure. The process 500 includes obtaining (510) a target data source. An indication of a target data source and/or a node associated with the target data source can be obtained as described herein.

Traffic data can be determined (512). Traffic data can be used to represent the popularity of the data source. Traffic data can be computed based on the unique number of users that visit it and the total number of URL requests they made on a single day. In several embodiments, page views corresponding to different requests are counted separately only if they are 30 minutes apart from each other. In many embodiments, the traffic data can be scaled for a more compact representation.

A bounce rate can be determined (514). A bounce rate is an engagement statistic showing the level of interest visitors have in the content of a data source. The bounce rate for a data source can be measured as the percentage of visits that consist of a single page view (e.g. when the visitor does not click on any of the links on the landing page.) In many embodiments, the bounce rate is relatively higher for low-factuality sites as compared to high-factuality sites.

A link score can be determined (516). A link score is a measure of the number of data sources in the that link to the target data source. In many embodiments, the link score excludes links placed to influence search engine rankings of the linked data source.

Viewing behavior data can be determined (518). Viewing behavior data can include a variety of metrics indicating user engagement with a data source, such as daily page views per visitor and daily time on site. Average daily page views per visitor indicates the average number of pages viewed or refreshed by visitors to the data source. Daily time on site per visitor measures the average time that a visitor spends on the data source each day.

Metadata can be generated (520). The metadata can be generated based on the traffic data, bounce rate, link score, and/or viewing behavior data for the target data source. The metadata can be associated with and/or included in the node for the target data source and stored in the data source database as described herein.

Specific processes for determining metadata for a data source in accordance with the invention are described in FIG. 5. However, it should be understood that any variety of processes, including those that utilize fewer or more characteristics or metrics for a particular data source to generate metadata, can be used as appropriate to the requirements of the specific application of the embodiments of the invention.

Data source profiling processes can include identifying data sources that are similar to a target data source and generating a source similarity graph indicating those similar data sources. This source similarity graph encodes the similarity between the target data source and the similar data sources based on a variety of factors, such as audience overlap and metadata attributes. In many embodiments, the source similarity graph can be iteratively expanded by adding new neighboring nodes for the similar data sources to provide a comprehensive representation of the audience overlap for the data sources.

FIG. 6 illustrates a flowchart of a process for generating a source similarity graph in accordance with an example embodiment of the present disclosure. The process 600 includes obtaining (610) a target data source node. The target data source node can indicate a data source and be stored in a data source database as described herein.

Similar data source nodes can be determined (612). In many embodiments, data source nodes that are similar to the target data source node are determined based on audience overlap. Audience overlap can be determined based on shared visitors, the overlap in keywords used by the data source, and/or similarities in the metadata attributes for the data sources. In many embodiments, a score is computed to quantify the degree of overlap for each pair of similar sites. In several embodiments, a third-party system is used to obtain audience overlap data. For example, the siteinfo3 tool provides a list of 4-5 data sources that are most similar to a target data source determined based on an audience overlap statistic.

A source similarity graph can be generated (614). The source similarity graph can be generated based on the target data source node, the similar data source nodes, and/or a similarity score for each pair of sites. The source similarity graph can be undirected, directed, and/or weighted based on the requirements of specific applications of embodiments of the invention. Each node in the source similarity graph can represent a data source node and the edges connecting the nodes can be weighted to indicate the degree of similarity between each pair of nodes. A source similarity graph with a single node (e.g. the target data source node) can be referred to as a level 0 source similarity graph. A source similarity graph with a set of similar data source nodes linked to the target data source node can be referred to as a level 1 source similarity graph. A level 2 source similarity graph has, for each of the set of similar data source nodes, a second set of similar data source node. Level 3 and higher source similarity graphs can be iteratively generated in a similar manner. In particular, it should be noted that the level of the source similarity graph is related to the accuracy of the classification of the target data source and the computational complexity associated with classifying the target data source. In a variety of embodiments, the generated source similarity graph is a level 4 source similarity graph.

A data source database can be updated (616). The data source database can be updated to include the generated source similarity graph. In this way, the source similarity graph does not need to be re-generated each time the target data source is analyzed. Additionally, this allows for the source similarity graph for the target data source to be manually and/or automatically updated as new nodes are added to the data source database as described herein.

Specific processes for generating a source similarity graph in accordance with the invention are described in FIG. 6. However, it should be understood that any variety of processes, including those that utilize alternative techniques for determining similar data sources, can be used as appropriate to the requirements of the specific application of the embodiments of the invention.

Data source profiling processes can include generating a similarity embedding for a target data source. The similarity embedding indicates the data source's most common neighbors in the data source database, thereby grouping data sources into cohorts based on their similarity. The target data source can then be classified by generating one or more labels for the target data source; the one or more labels being based on the labels for the other data sources in the cohort. In a variety of embodiments, the label generation can be augmented based on textual representations extracted from content provided by the data sources.

FIG. 7 illustrates a flowchart of a process for classifying a data source in accordance with an example embodiment of the present disclosure. The process 700 includes obtaining (710) a source similarity graph for target data source node. The source similarity graph can indicate a data source and/or be stored in a data source database as described herein.

A similarity embedding can be generated (712). The similarity embedding can be generated based on the source similarity graph and the data source database. In many embodiments, a machine classifier is used to generate the similarity embedding. In a number of embodiments, a graph neural network (GNN) is used to sample random walks of a fixed maximum length through the data source database for every source data node in the source similarity graph. These sequences of random walks can be used with a skip-gram model learn representations for the target data source node and/or each node in the data source database and/or source similarity graph. In many embodiments, the representation is a 512-dimensional vector representation, although any representation can be used as appropriate.

It should be readily apparent to one having ordinary skill in the art that any of a variety of machine classifiers can be utilized including (but not limited to) decision trees, k-nearest neighbors, support vector machines (SVM), neural networks (NN), recurrent neural networks (RNN), convolutional neural networks (CNN), and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, genetic scale RNNs, and/or transformers. In a number of embodiments, a combination of machine classifiers can be utilized, more specific machine classifiers when available, and general machine classifiers at other times can further increase the accuracy of predictions. For example, a single machine classifier can be trained using concatenation of different features indicated in the data source nodes and used to label the data source nodes. In another example, separate classifiers can be trained for each feature and an average of the posterior probabilities obtained by every machine classifier can be used to generate the labels for the data source nodes.

The target data source can be classified (714). The classification of the target data source can be determined based on the labels generated for the data source node(s). The classification can indicate any desired feature(s) of a data source, such as factuality, bias, political leaning, and the like. Each feature can be modeled on its own scale. For example, factuality can modeled on a three-point scale—high, mixed and low, while political leaning can be labeled as far left, left, center, right, and far right. However, it should be noted that any feature and any model for the feature(s) can be used as appropriate to the requirements of specific applications of embodiments of the invention.

The data source database can be updated (716). The data source database can be updated to include the generated classifications for the target data source node and/or the data source nodes indicated in the source similarity graph. In this way, the classification for a data source can be provided as described herein.

Specific processes for classifying a data source in accordance with the invention are described in FIG. 7. However, it should be understood that any variety of processes, including those that utilize alternative machine classifiers or that do not utilize machine classifiers to classify data sources, can be used as appropriate to the requirements of the specific application of the embodiments of the invention.

It will be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various embodiments of the disclosure.

Although the present disclosure has been described in certain specific embodiments, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Throughout this disclosure, terms like “advantageous”, “exemplary” or “preferred” indicate elements or dimensions which are particularly suitable (but not essential) to the disclosure or an embodiment thereof, and may be modified wherever deemed suitable by the skilled annotator, except where expressly required. Accordingly, the scope of the invention should be determined not by the embodiments illustrated, but by the appended claims and their equivalents.

What is claimed is:

1. A computer-implemented method for profiling a data source, comprising:
obtaining an indication of a first data source;
determining visitor and keyword data for the first data source;
determining metadata for the first data source;
generating a source similarity graph for the first data source, the source similarity graph indicating at least one similar data source and, for each similar data source, a bias score for the similar data source;
classifying the first data source based on the bias scores for the at least one similar data source;
generating a notification indicating the first data source and the classification of the first data source; and
providing the notification.

2. The computer-implemented method of claim 1, wherein the metadata comprises data selected from the group consisting of traffic rank data, bounce rate data, daily page views per visitor data, and time on site per visitor data.

3. The computer-implemented method of claim 1, further comprising obtaining the metadata using a third party server system.

4. The computer-implemented method of claim 1, further comprising obtaining the metadata using a local web traffic analyzer.

5. The computer-implemented method of claim 1, wherein the source similarity graph comprises an indication of a historical classification for the first data source.

6. The computer-implemented method of claim 1, further comprising generating the bias score by traversing the source similarity graph using a graph neural network.

7. The computer-implemented method of claim 1, wherein the notification is selected from the group consisting of a push notification, an email notification, a text message, and an audible alert.

8. A data source profiling device, comprising:
a processor; and
memory storing instructions that, when read by the processor, cause the data source profiling device to:
obtain an indication of a first data source;
determine visitor and keyword data for the first data source;
determine metadata for the first data source;
generate a source similarity graph for the first data source, the source similarity graph indicating at least one similar data source and, for each similar data source, a bias score for the similar data source;
classify the first data source based on the bias scores for the at least one similar data source;
generate a notification indicating the first data source and the classification of the first data source; and
provide the notification.

9. The data source profiling device of claim 8, wherein the metadata comprises data selected from the group consisting of traffic rank data, bounce rate data, daily page views per visitor data, and time on site per visitor data.

10. The data source profiling device of claim 8, wherein the metadata is obtained using a third party server system.

11. The data source profiling device of claim 8, wherein the metadata is obtained using a local web traffic analyzer.

12. The data source profiling device of claim 8, wherein the source similarity graph comprises an indication of a historical classification for the first data source.

13. The data source profiling device of claim 8, wherein the bias score is generated by traversing the source similarity graph using a graph neural network.

14. The data source profiling device of claim 8, wherein the notification is selected from the group consisting of a push notification, an email notification, a text message, and an audible alert.

15. A non-transitory computer readable medium storing instructions that, when executed by one or more processors, cause the one or more processors to perform steps comprising:
obtaining an indication of a first data source;
determining visitor and keyword data for the first data source;
determining metadata for the first data source;
generating a source similarity graph for the first data source, the source similarity graph indicating at least one similar data source and, for each similar data source, a bias score for the similar data source;
classifying the first data source based on the bias scores for the at least one similar data source;
generating a notification indicating the first data source and the classification of the first data source; and
providing the notification.

16. The non-transitory computer readable medium of claim 15, wherein the metadata comprises data selected from the group consisting of traffic rank data, bounce rate data, daily page views per visitor data, and time on site per visitor data.

17. The non-transitory computer readable medium of claim 15, wherein the instructions, when executed by one or more processors, further cause the one or more processors to perform steps comprising obtaining the metadata using a third party server system.

18. The non-transitory computer readable medium of claim 15, wherein the instructions, when executed by one or more processors, further cause the one or more processors to perform steps comprising obtaining the metadata using a local web traffic analyzer.

19. The non-transitory computer readable medium of claim 15, wherein the instructions, when executed by one or more processors, further cause the one or more processors to perform steps comprising generating the bias score by traversing the source similarity graph using a graph neural network.

20. The non-transitory computer readable medium of claim 15, wherein the notification is selected from the group consisting of a push notification, an email notification, a text message, and an audible alert.
